(19) United States
(12) Patent Application Publication
(10) Pub. No.: US 2026/0104707 A1
(43) Pub. Date: Apr. 16, 2026

(54) METHOD AND SYSTEM FOR AUTONOMOUS ROBOT EXPLORATION BASED ON FRONTIER REGION LEARNING

(71) Applicant: EWHA University - Industry Collaboration Foundation, Seoul (KR)

(72) Inventors: Young Jun KIM, Seoul (KR); Kyung Min HAN, Seoul (KR)

(73) Assignee: EWHA University - Industry Collaboration Foundation, Seoul (KR)

(21) Appl. No.: 19/345,681

(22) Filed: Sep. 30, 2025

(30) Foreign Application Priority Data
Oct. 11, 2024 (KR) 10-2024-0138440

(51) Int. Cl. G05D 1/246; G05D 101/15; G05D 105/80; G05D 109/10

(52) U.S. Cl. CPC G05D 1/2464; G05D 2101/15; G05D 2105/87; G05D 2109/10

(57) ABSTRACT

A method and system for autonomous robot exploration based on frontier region learning are provided. The learning-based autonomous robot exploration system includes a frontier region detector configured to detect a frontier region corresponding to a real-time grid map by inputting the real-time grid map of a region in which a robot is located to a frontier region detection network, a distance predictor configured to measure a distance between the robot and each frontier point included in the detected frontier region, and a frontier point determiner configured to determine, among frontier points, a frontier point to which the robot moves for exploration based on the distance between the robot and each frontier point.

### CROSS-REFERENCE TO RELATED APPLICATIONS

This application claims the benefit of Korean Patent Application No. 10-2024-0138440, filed on Oct. 11, 2024, in the Korean Intellectual Property Office, the entire disclosure of which is incorporated herein by reference for all purposes.

### BACKGROUND

### 1. Field of the Invention

One or more embodiments relate to a method and system for autonomous robot exploration based on frontier region learning, and more particularly, to a method and system for determining, among frontier points in a frontier region between unknown cells and free cells, a frontier point to which a robot moves for exploration.

### 2. Description of the Related Art

Autonomous exploration using a robot is one of the fundamental tasks of mobile robots, in which an incremental map is used so that the robot does not revisit already covered regions while searching and exploring unknown spaces.

Conventional autonomous exploration systems perform exploration after searching a frontier region between unknown cells and free cells, based on a greedy exploration strategy.

However, in these conventional autonomous exploration systems, a frontier point closest to the robot is selected among frontier points included in the frontier region, and exploration proceeds from the selected frontier point. Accordingly, the selected frontier point is often not the most efficient point relative to the current location of the robot, resulting in limitations in exploration efficiency.

Therefore, there is a demand for a method that may improve exploration efficiency of a robot performing indoor exploration.

### SUMMARY

Embodiments provide a method and system for improving the exploration efficiency of a robot performing indoor exploration by identifying a frontier region and determining, based on distances between the robot and frontier points in the frontier region and on coverage rewards of the frontier points, a frontier point to which the robot moves for exploration.

According to an aspect, there is provided a learning-based autonomous robot exploration system including a frontier region detector configured to detect a frontier region corresponding to a real-time grid map by inputting the real-time grid map of a region in which a robot is located to a frontier region detection network, a distance predictor configured to measure a distance between the robot and each frontier point included in the detected frontier region, and a frontier point determiner configured to determine, among frontier points, a frontier point to which the robot moves for exploration based on the distance between the robot and each frontier point.

According to an embodiment, the frontier region detector of the learning-based autonomous robot exploration system may receive input information including a map in which a real-time exploration result is illustrated as an image and the location of the robot and may generate the real-time grid map by converting the map in which the real-time exploration result is illustrated as an image so that the location of the robot is at the center.

According to an embodiment, the frontier region detection network of the learning-based autonomous robot exploration system may be a network trained to detect a frontier region using a training grid map and frontier region information set as a ground-truth label corresponding to the training grid map.

According to an embodiment, the frontier region detector of the learning-based autonomous robot exploration system may perform a fast front propagation (FFP)+ method including setting one of unknown cells as a seed cell, performing exploration from the seed cell, searching a frontier region adjacent to a free cell among unknown cells, performing inner propagation from the location of a robot in a free cell, and searching a frontier region adjacent to an unknown cell among free cells.

According to an embodiment, the frontier region detector of the learning-based autonomous robot exploration system may output a frontier region (FR) map illustrating the detected frontier region, and the distance predictor may measure a score according to the distance between the robot and each frontier point by inputting an obstacle map generated by extracting regions identified as obstacles from the real-time grid map, Gaussian robot location information, and the FR map to a distance measurement network.

According to an embodiment, the distance predictor of the learning-based autonomous robot exploration system may train the distance measurement network by determining an A* map illustrating a distance between the robot and each frontier point detected from a training grid map using an A* algorithm, generating an inverted A* map by inverting the A* map, and setting the inverted A* map as a ground-truth label.

According to an embodiment, the Gaussian robot location information of the learning-based autonomous robot exploration system may be an image generated by applying a Gaussian distribution around the location of the robot after placing the robot at the center of the image.

According to another aspect, there is provided a learning-based autonomous robot exploration system including a frontier region detector configured to detect a frontier region corresponding to a real-time grid map by inputting the real-time grid map of a region in which a robot is located to a frontier region detection network, a coverage reward predictor configured to predict a coverage reward generatable when the robot moves to a corresponding frontier point for each frontier point included in the detected frontier region, and a frontier point determiner configured to determine, among frontier points, a frontier point to which the robot moves for exploration based on the predicted coverage reward.

According to an embodiment, the frontier region detector of the learning-based autonomous robot exploration system may output an FR map illustrating the detected frontier region, and the coverage reward predictor may predict the coverage reward by inputting the real-time grid map and the FR map to a coverage reward prediction network.

According to an embodiment, the coverage reward predictor of the learning-based autonomous robot exploration system may place a virtual robot at each frontier point of a training grid map, perform 360-degree ray-shooting from the virtual robot, determine whether pixels hit by rays correspond to obstacles, set a visibility map illustrating an obstacle determination result as a ground-truth label, and train the coverage reward prediction network using the visibility map.

According to an embodiment, the frontier region detection network of the learning-based autonomous robot exploration system may be a network trained to detect a frontier region using a training grid map and frontier region information set as a ground-truth label corresponding to the training grid map.

According to another aspect, there is provided a learning-based autonomous robot exploration system including a frontier region detector configured to detect a frontier region corresponding to a real-time grid map by inputting the real-time grid map of a region in which a robot is located to a frontier region detection network, a coverage reward predictor configured to predict a coverage reward generatable when the robot moves to a corresponding frontier point for each frontier point included in the detected frontier region, a distance predictor configured to measure a distance between the robot and each frontier point included in the detected frontier region, and a frontier point determiner configured to determine, among frontier points, a frontier point to which the robot moves for exploration based on the distance between the robot and each frontier point.

According to an embodiment, the frontier point determiner of the learning-based autonomous robot exploration system may determine the frontier point by applying a greater weight to the coverage reward than to the distance between the robot and each frontier point.

According to an embodiment, the frontier region detection network of the learning-based autonomous robot exploration system may be a network trained to detect a frontier region using a training grid map and frontier region information set as a ground-truth label corresponding to the training grid map and may output an FR map illustrating a frontier region corresponding to the real-time grid map.

According to an embodiment, the distance predictor of the learning-based autonomous robot exploration system may measure a score according to the distance between the robot and each frontier point by inputting an obstacle map generated by extracting regions identified as obstacles from the real-time grid map, Gaussian robot location information, and the FR map to a distance measurement network.

According to an embodiment, the coverage reward predictor of the learning-based autonomous robot exploration system may place a virtual robot at each frontier point of a training grid map, perform 360-degree ray-shooting from the virtual robot, determine whether pixels hit by rays correspond to obstacles, set a visibility map illustrating an obstacle determination result as a ground-truth label, and train a coverage reward prediction network using the visibility map, and may predict the coverage reward by inputting the real-time grid map and the FR map to the coverage reward prediction network.

According to embodiments, the exploration efficiency of a robot performing indoor exploration may be improved by identifying a frontier region and determining, based on distances between the robot and frontier points in the frontier region and on coverage rewards of the frontier points, a frontier point to which the robot moves for exploration.

### BRIEF DESCRIPTION OF THE DRAWINGS

FIG. 1 is a diagram illustrating a learning-based autonomous robot exploration system according to an embodiment.

FIG. 2 illustrates an example of a map generated during exploration by a robot according to an embodiment.

FIG. 3 illustrates an example of a frontier region detection process according to an embodiment.

FIG. 4 illustrates an example of a grid map of into a robot-centered coordinate system according to an embodiment.

FIG. 5 illustrates an example of an operation of a frontier region detector according to an embodiment.

FIG. 6 illustrates an example of a visibility map generation process according to an embodiment.

FIG. 7 illustrates an example of information input to a distance predictor according to an embodiment.

FIG. 8 illustrates an example of an operation of a distance predictor according to an embodiment.

FIG. 9 illustrates an example of a distance measurement result output by a distance predictor according to an embodiment.

FIG. 10 illustrates an example of information input to a coverage reward predictor according to an embodiment.

FIG. 11 illustrates an example of an operation of a coverage reward predictor according to an embodiment.

FIG. 12 illustrates an example of a coverage reward prediction result output by a coverage reward predictor according to an embodiment.

FIG. 13 illustrates an example of an exploration result according to an embodiment.

FIG. 14 is a flowchart illustrating a learning-based autonomous robot exploration method according to an embodiment.

### DETAILED DESCRIPTION

Hereinafter, examples will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

In the descriptions of the examples referring to the accompanying drawings, like reference numerals refer to like elements and any repeated description related thereto will be omitted. In the description of example embodiments, detailed description of well-known related structures or functions will be omitted when it is deemed that such description will cause ambiguous interpretation of the present disclosure.

Hereinafter, example embodiments will be described in detail with reference to the accompanying drawings.

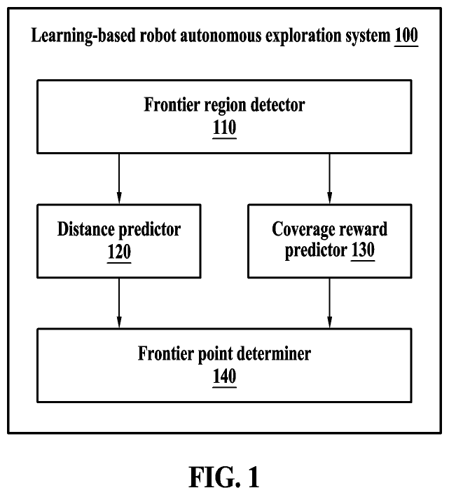

FIG. 1 is a diagram illustrating a learning-based autonomous robot exploration system according to an embodiment.

As illustrated in FIG. 1, a learning-based autonomous robot exploration system 100 may include a frontier region detector 110, a distance predictor 120, a coverage reward predictor 130, and a frontier point determiner 140. In this case, the frontier region detector 110, the distance predictor 120, the coverage reward predictor 130, and the frontier point determiner 140 may be implemented as separate processors as illustrated in FIG. 1, or as respective modules included in a program executed by a single processor.

The frontier region detector 110 may detect a frontier region corresponding to a real-time grid map by inputting the real-time grid map of a region in which the robot is located to a frontier region detection network. The frontier region detector 110 may receive, from the robot, input information including a map in which a real-time exploration result is illustrated as an image and the location of the robot. In addition, the frontier region detector 110 may generate the real-time grid map by converting a map in which a previous exploration result is illustrated as an image so that the robot is located at the center.

The frontier region detection network may be a network trained to detect a frontier region using a training grid map and corresponding frontier region information set as a ground-truth label. For example, the frontier region detection network may be a frontier region (FR)-Net based on a U-Net architecture and may output an FR map illustrating the detected frontier region.

The distance predictor 120 may measure a distance between the robot and each frontier point included in the frontier region detected by the frontier region detector 110.

The distance predictor 120 may measure a score according to a distance between the robot and each frontier point by inputting, to a distance measurement network, an obstacle map generated by extracting regions identified as obstacles from the real-time grid map, Gaussian robot location information, and the FR map. In this case, the Gaussian robot location information may be an image generated by applying a Gaussian distribution around the location of the robot, with the robot placed at the center of the image. For example, the distance measurement network may be an A*-Net trained by an A* algorithm.

In addition, the distance predictor 120 may determine an A* map illustrating distances between the robot and respective frontier points detected in the training grid map using the A* algorithm, generate an inverted A* map by inverting the A* map, and train the distance measurement network by defining the inverted A* map as a ground-truth label.

The coverage reward predictor 130 may predict, for each frontier point included in the frontier region detected by the frontier region detector 110, a coverage reward obtained when the robot moves to the corresponding frontier point.

The coverage reward predictor 130 may predict a coverage reward by inputting the real-time grid map and the FR map to a coverage reward prediction network. For example, the coverage reward prediction network may be a Viz-Net.

In addition, the coverage reward predictor 130 may place a virtual robot at each frontier point of the training grid map, perform 360-degree ray-shooting from the virtual robot, determine whether each pixel hit by the rays corresponds to an obstacle, and train the coverage reward prediction network by defining a visibility map illustrating an obstacle determination result as a ground-truth label.

The frontier point determiner 140 may determine, among the frontier points, a frontier point to which the robot moves for exploration based on the distance between the robot and each frontier point measured by the distance predictor 120. In addition, the frontier point determiner 140 may determine, among the frontier points, a frontier point to which the robot moves for exploration based on the coverage reward predicted by the coverage reward predictor 130.

In addition, the frontier point determiner 140 may determine, among the frontier points, a frontier point to which the robot moves for exploration based on both the distance between the robot and each frontier point measured by the distance predictor 120 and the coverage reward predicted by the coverage reward predictor 130. In this case, the frontier point determiner 140 may determine the frontier point by applying a greater weight to the coverage reward than to the distance between the robot and each frontier point.

According to an embodiment, the learning-based autonomous robot exploration system may improve the exploration efficiency of a robot performing indoor exploration by identifying a frontier region and determining, based on distances between the robot and frontier points in the frontier region and coverage rewards of the frontier points, a frontier point to which the robot moves for exploration.

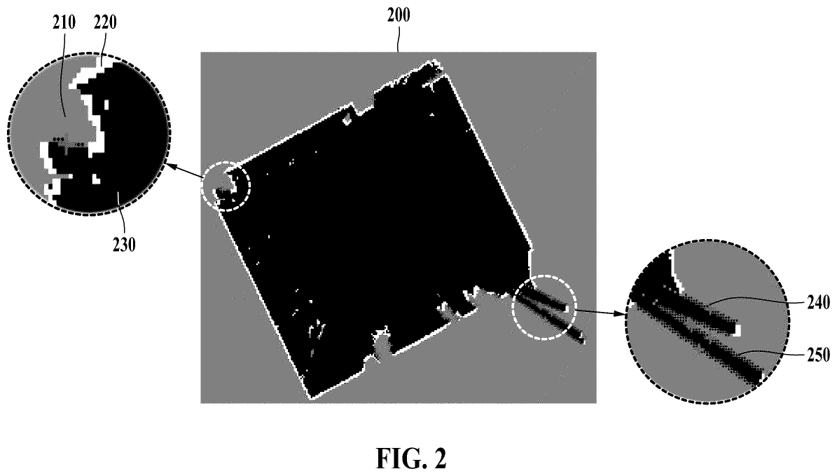

FIG. 2 illustrates an example of a map generated during exploration by a robot according to an embodiment.

As illustrated in FIG. 2, a map 200 generated during exploration by the robot may be classified into one of an unknown cell Mu 210 that has not yet been explored, an occupied cell Mo 220 corresponding to an obstacle, and a free cell Mf 230 that is unoccupied in a space explored by the robot. Accordingly, an occupancy M(x) of a cell x may be defined by Equation 1.

$$ℳ ( x ) = \{ \begin{matrix}OCCUPIED & if x ∈ {ℳ}_{o} \\ UNKNOWN & if x ∈ {ℳ}_{u} \\ FREE & if x ∈ {ℳ}_{f}\end{matrix} . \qquad [ Equation 1 ]$$

In addition, a set 250 of cells Mu 210 adjacent to the cell M_{f} 230 may be defined as a frontier region [symbol] :=∂ [symbol] u. The geometric center of an ith frontier region Fᵢ may be defined as a frontier point cᵢ 240. Accordingly, an ith frontier point fᵢ may be the point closest to the frontier point cᵢ 240 among all points included in the ith frontier region Fᵢ and may be defined by Equation 2.

$${f}_{i} = \{ x \vert {arg min}_{x} ‖ {c}_{i} - x ‖ and x ∈ {ℱ}_{i} \} . \qquad [ Equation 2 ]$$

The ith frontier point fᵢ may be ∥fᵢ−r∥≤η and may be considered covered when fᵢ∉ [symbol] u r∈ [symbol] represents the location of the robot, and n denotes a constant that varies depending on a sensor range.

f⁺ may be an optimal frontier point selected by a reference function C(·) among frontier point candidates {∀fᵢ} and may be set as a frontier point to which the robot moves for exploration.

The objective of an exploration task is to visit all reachable unknown regions until an exploration space is completely covered or, equivalently, no frontier points to be explored remain. Accordingly, the learning-based autonomous robot exploration system may determine f* to efficiently guide the robot to complete the exploration task.

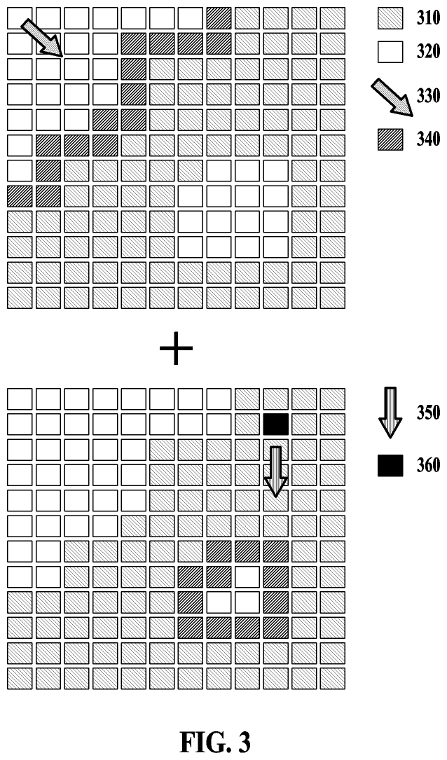

FIG. 3 illustrates an example of a frontier region detection process according to an embodiment.

The frontier region detector 110 may detect a frontier region 340 by combining a fast front propagation (FFP) method illustrated in an upper portion of FIG. 3 and a dual fast front propagation (DFFP) method illustrated in a lower portion of FIG. 3.

The FFP method is a method of searching a frontier region 340 adjacent to a free cell 310 among unknown cells 320 by setting one of the unknown cells 320 as a seed cell and performing exploration starting from the seed cell. However, as illustrated in FIG. 3, if separate unknown cells 320 exist inside the frontier region 340, an outer frontier region 330 may not be searched by the FFP method alone.

The DFFP method is a method of searching a frontier region 340 adjacent to an unknown cell 320 among free cells 310 by performing inner propagation from a location 350 of a robot in a free cell 310 and thus may also detect a frontier region 340 of an unknown cell 320 located inside the free cells 310. However, since the DFFP method performs exploration inside a free cell 310, a frontier region 340 of a free cell 310 that is located inside the unknown cells 320 and not connected to the free cell 310 in which the robot is located may not be detected.

In other words, the frontier region detector 110 may detect both the frontier region 340 of unknown cells 320 located inside free cells 310 and the frontier region 340 of free cells 310 located inside unknown cells 320 using an FFP+ method that combines the FFP method and the DFFP method.

Specifically, the FFP+ method may be a method of searching a frontier region 340 adjacent to free cells 310 among unknown cells 320 by setting one of the unknown cells 320 as a seed cell, performing exploration from the seed cell, and performing inner propagation from the location 350 of the robot in a free cell 310 to search a frontier region 340 adjacent to unknown cells 320.

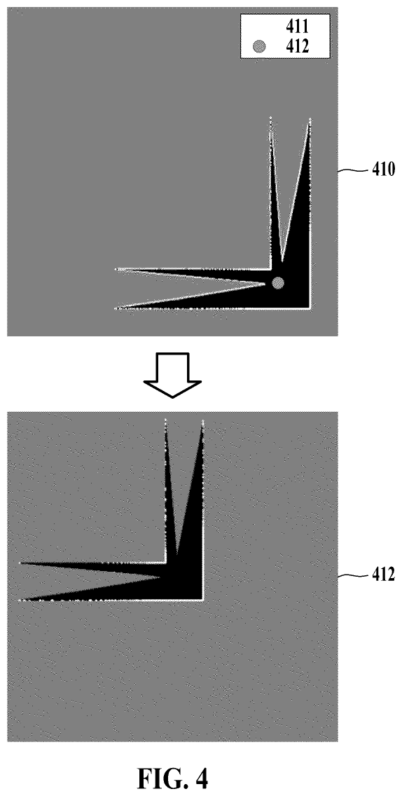

FIG. 4 illustrates an example of a grid map of into a robot-centered coordinate system according to an embodiment.

The frontier region detector 110 may receive input information including a map 410 in which a real-time exploration result is illustrated as an image and a location 412 of the robot. In this case, as illustrated in FIG. 4, the map 410 may include a frontier region 411 according to an exploration result.

The frontier region detector 110 may generate a real-time grid map 420 by converting a location at which a real-time exploration result is displayed on the map 410 so that the location 412 of the robot is at the center.

In addition, the frontier region detector 110 may receive input information including a training map in which an actual exploration result is illustrated as an image and the location of the robot. The frontier region detector 110 may generate a training grid map by converting the location at which the actual exploration result is displayed on the training map so that the location of the robot is at the center.

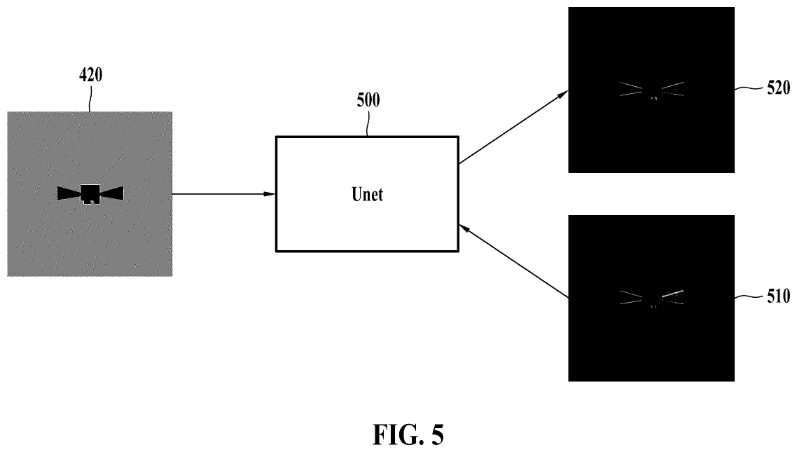

FIG. 5 illustrates an example of an operation of a frontier region detector according to an embodiment.

The frontier region detector 110 may train a U-Net 500 using a training grid map and corresponding frontier region information 510 set as a ground-truth label. For example, the frontier region information 510 may be an FR map corresponding to the training grid map.

The frontier region detector 110 may output an FR map 520 illustrating a frontier region corresponding to the real-time grid map 420 by inputting the real-time grid map 420 of a region in which a robot is located to the trained U-Net 500.

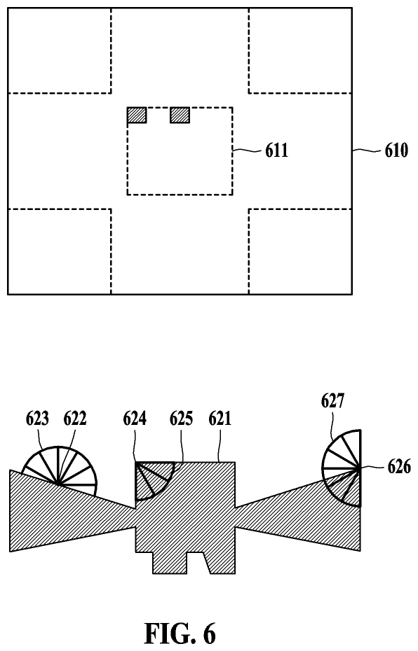

FIG. 6 illustrates an example of a visibility map generation process according to an embodiment.

As illustrated in FIG. 6, the coverage reward predictor 130 may receive a training map 610 illustrating the location of obstacle 611 and training grid maps 621 corresponding to the location of the robot set during exploration in the training map 610.

The coverage reward predictor 130 may place a virtual robot at frontier points 622, 624, and 626, which are centers of frontier regions of a training grid map.

As illustrated in FIG. 6, the coverage reward predictor 130 may determine whether a pixel hit by a ray corresponds to an obstacle by performing 360-degree ray-shooting from each of the frontier points 622, 624, and 626 at which the virtual robot is placed. In the example of FIG. 6, an obstacle determination result 623 of the frontier point 622 indicates that no obstacles are detected in the entire 180-degree range, an obstacle determination result 625 of the frontier point 624 indicates that all regions except for a 90-degree range are determined as obstacles, and an obstacle determination result 627 of the frontier point 626 indicates that no obstacles are detected in a 180-degree range. However, while the frontier point 622 has no obstacles detected in a 180-degree direction toward unknown cells, the frontier point 626 has part of the 180-degree direction without obstacles determined as free cells. Accordingly, the coverage reward predictor 130 may determine coverage rewards of the frontier points in the order of frontier point 622>frontier point 626>frontier point 624. The coverage reward predictor 130 may also generate a visibility map in which coverage rewards of the frontier points 622, 624, and 626 are illustrated.

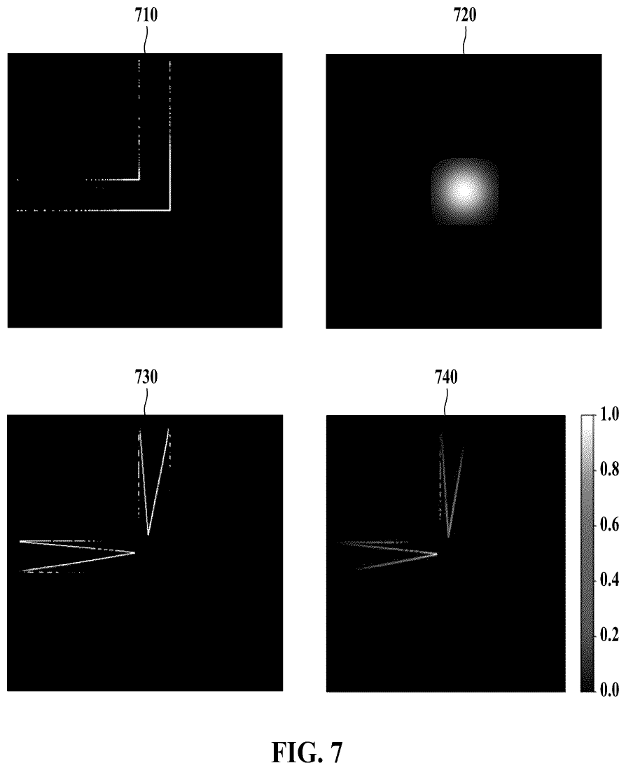

FIG. 7 illustrates an example of information input to a distance predictor according to an embodiment.

The distance predictor 120 may train a distance measurement network by inputting an obstacle map 710, Gaussian robot location information 720, an FR map 730, and an inverted A* map 740 to the distance measurement network.

The obstacle map 710 may be a map generated by extracting regions identified as obstacles in a real-time grid map.

The Gaussian robot location information 720 may be an image generated by applying Gaussian distribution around the location of a robot after placing the robot at the center of the image.

The FR map 730 may be output by the frontier region detector 110 and may be the FR map 520 illustrating a frontier region corresponding to the real-time grid map 420.

The inverted A* map 740 may be a map that is input to the distance measurement network as a ground-truth label. The distance predictor 120 may determine an A* map illustrating distances between the robot and respective frontier points detected in the training grid map using an A* algorithm and may generate the inverted A* map by inverting the determined A* map.

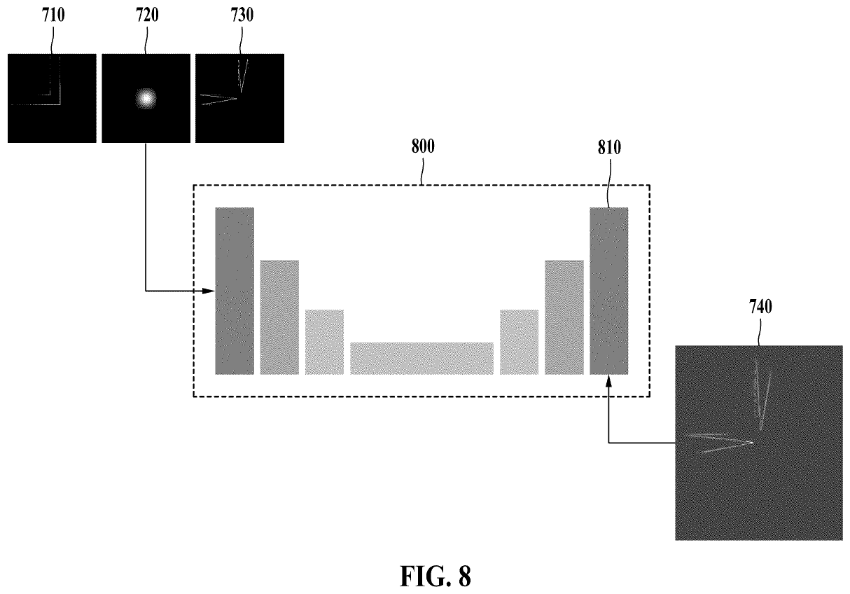

FIG. 8 illustrates an example of an operation of a distance predictor according to an embodiment.

The distance predictor 120 may train a distance measurement network 800 by inputting a training obstacle map, training Gaussian robot location information, and a training FR map to the distance measurement network 800, and by setting the inverted A* map 740 as a ground-truth label for the distance measurement network 800. For example, the distance measurement network 800 may be an A*-Net using an A* algorithm. In addition, the A*-Net may be a network based on a U-Net architecture having a tanh activation function in a final output layer to ensure continuous and normalized output values.

The distance measurement network 800 may learn and predict a cost value from a start node n to a target node by evaluating a cost function F(n) including a path length measured from the start node n to the target node using the training obstacle map, the training Gaussian robot location information, and the training FR map, and a heuristic function, as well as a lower bound distance from the start node n to the target node. For example, the training obstacle map may be the inverted A* map.

Specifically, measurement network may learn the distance 800 \tilde{F}(·)=1−F(·), which is an inverse estimate of a normalized cost F(·).

The trained distance measurement network 800 may output a distance map 810 illustrating a score according to a distance between a robot and each frontier point upon receiving the obstacle map 710, the Gaussian robot location information 720, and the FR map 730. For example, the distance map 810 may be the inverted A* map.

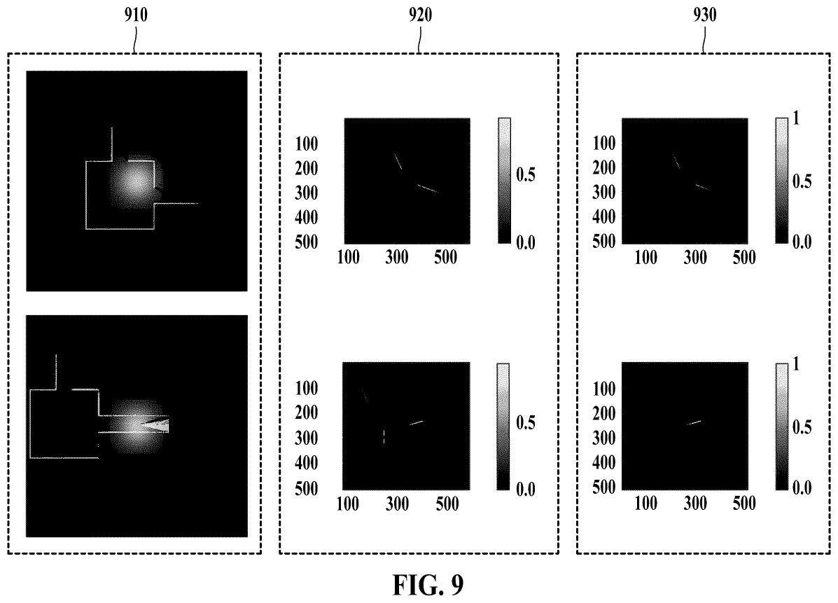

FIG. 9 illustrates an example of a distance measurement result output by a distance predictor according to an embodiment.

The distance predictor 120 may output a distance map 920 illustrating a distance measurement result from input information 910 including a map in which a real-time exploration result is illustrated as an image and the location of a robot. The distance map 920 output by the distance predictor 120 may be an image similar to a ground-truth label 930 within an error range, as illustrated in FIG. 9.

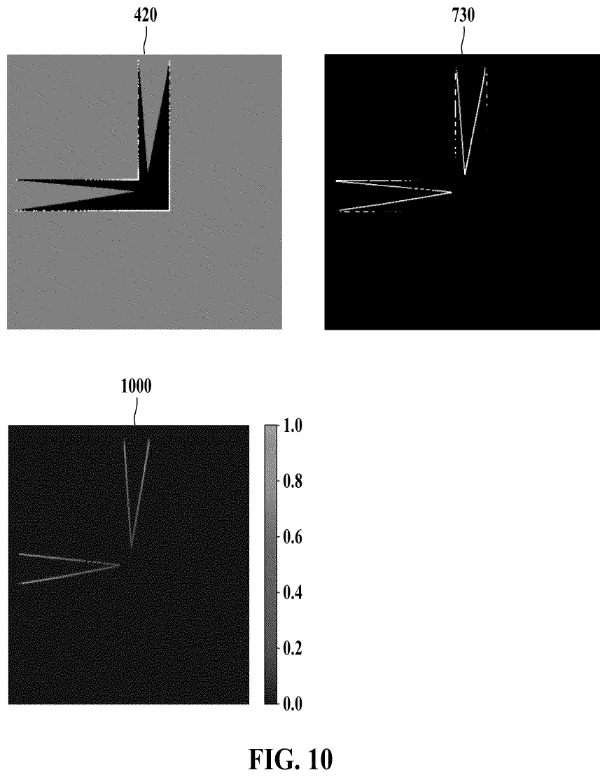

FIG. 10 illustrates an example of information input to a coverage reward predictor according to an embodiment.

The coverage reward predictor 130 may train a coverage reward prediction network by inputting the real-time grid map 420, and the FR map 730 to the coverage reward prediction network.

The visibility map 1000 may be a map generated by performing 360-degree ray-shooting from a virtual robot placed at each frontier point of a training grid map and illustrating a result of determining whether pixels hit by the rays correspond to obstacles.

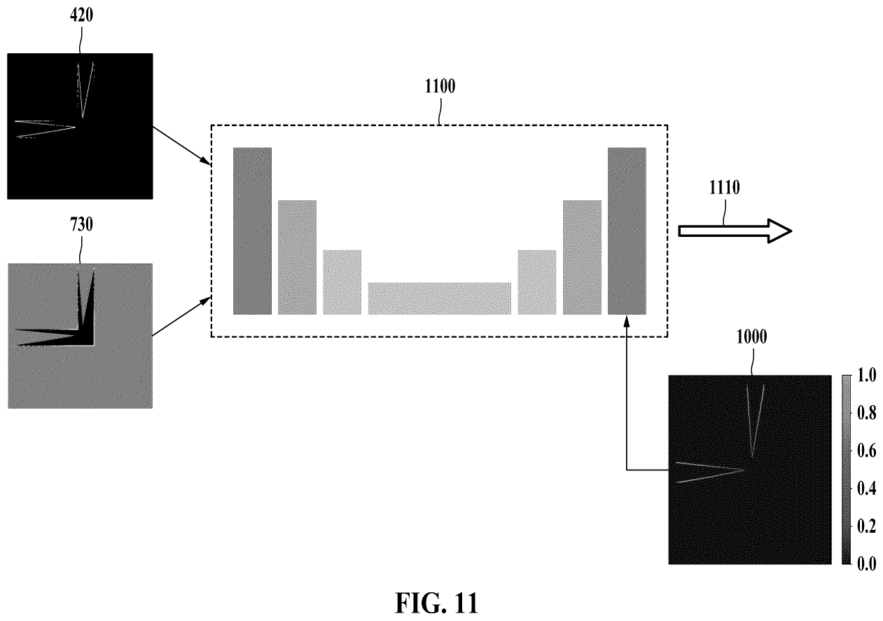

FIG. 11 illustrates an example of an operation of a coverage reward predictor according to an embodiment.

A coverage reward prediction network 1100 may be trained using a training grid map, a training FR map, and the visibility map 1000. For example, the coverage reward prediction network 1100 may be a Viz-Net.

The trained coverage reward prediction network 1100 may output a coverage reward map 1110 illustrating, for each frontier point, a coverage reward that may be generated when the robot moves to the corresponding frontier point, upon receiving the real-time grid map 420 and the FR map 730.

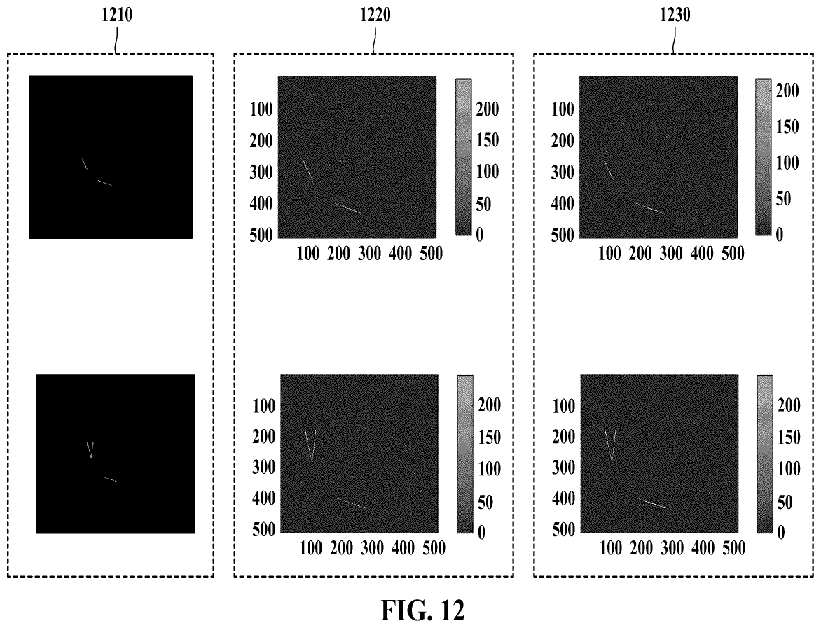

FIG. 12 illustrates an example of a coverage reward prediction result output by a coverage reward predictor according to an embodiment.

The coverage reward predictor 130 may output a coverage reward map 1220 illustrating coverage rewards from input information 1210 including the real-time grid map 420 and the FR map 730. The coverage reward map 1220 output by the coverage reward predictor 130 may be an image similar to a ground-truth label 1230 within an error range, as illustrated in FIG. 12.

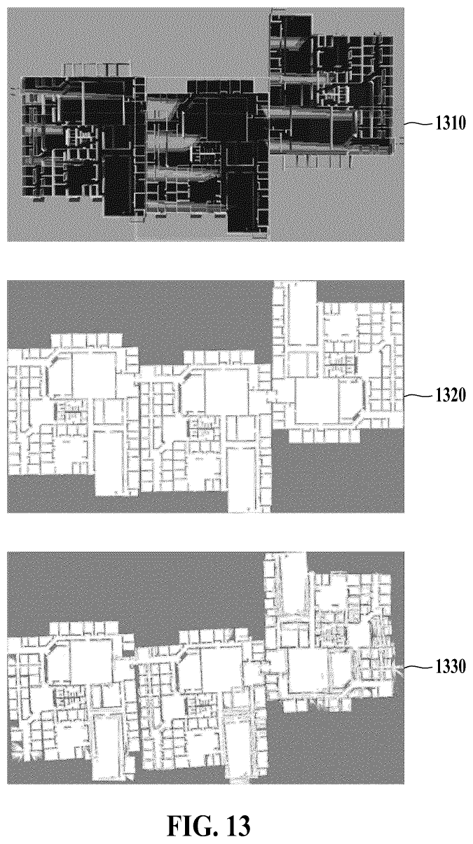

FIG. 13 illustrates an example of an exploration result according to an embodiment.

Referring to FIG. 13, a map 1310 illustrates a WG×3 world, a map 1320 may be generated by exploring terrain corresponding to the map 1310 while providing the robot's exact location, and a map 1330 may be generated as an exploration result according to an embodiment.

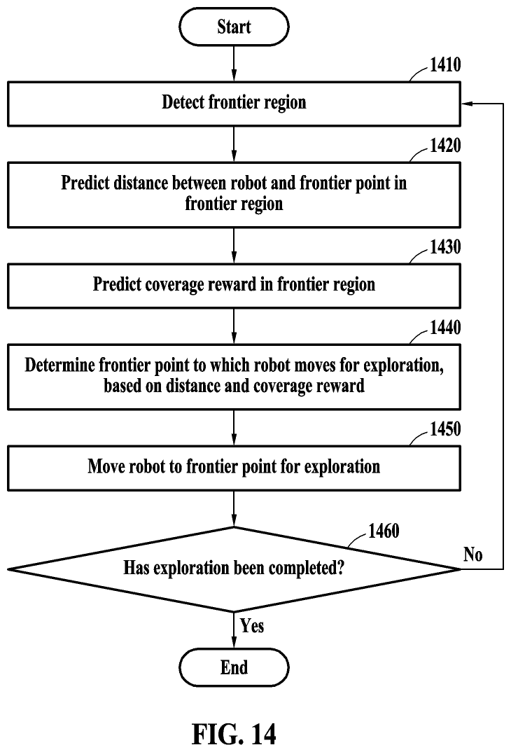

FIG. 14 is a flowchart illustrating a learning-based autonomous robot exploration method according to an embodiment.

In operation 1410, the frontier region detector 110 may detect a frontier region corresponding to a real-time grid map by inputting a real-time grid map of a region in which a robot is located to a frontier region detection network.

In operation 1420, the distance predictor 120 may measure a distance between the robot and each frontier point included in the frontier region detected in operation 1410. In this case, the distance predictor 120 may measure a score according to the distance between the robot and each frontier point by inputting an obstacle map generated by extracting regions identified as obstacles in the real-time grid map, Gaussian robot location information, and an FR map to a distance measurement network.

In operation 1430, the coverage reward predictor 130 may predict a coverage reward for each frontier point included in the frontier region detected in operation 1410, which may be generated when the robot moves to the corresponding frontier point. In this case, the coverage reward predictor 130 may predict the coverage reward by inputting the real-time grid map and the FR map to a coverage reward prediction network.

In operation 1440, the frontier point determiner 140 may determine, among frontier points, a frontier point to which the robot moves for exploration, based on the distance between the robot and each frontier point measured in operation 1420 and the coverage reward predicted in operation 1430.

For example, the frontier point determiner 140 may determine f* as a frontier point to which the robot moves for exploration using Equation 3.

$${f}^{*} = {arg max}_{i} ( λ {\tilde{F}}_{i} + ( 1 - λ ) {V}_{i} ) , ∃ λ ∈ [ 0 , 1 ] \qquad [ Equation 3 ]$$

Here, \tilde{F}ᵢ denotes a score according to the distance between the robot and each frontier point or a distance map, and Vᵢ denotes a coverage reward or a coverage reward map. In addition, λ denotes a relative weight between the coverage reward and the distance between the robot and each frontier point. For example, if λ=1, the frontier point determiner 140 may determine, among frontier points, a frontier point to which the robot moves for exploration based on the distance between the robot and each frontier point measured in operation 1420. On the other hand, if λ=0, the frontier point determiner 140 may determine, among frontier points, a frontier point to which the robot moves for exploration based on the coverage reward predicted in operation 1430.

In this case, the frontier point determiner 140 may determine a frontier point to which the robot moves for exploration by applying a greater weight to the coverage reward than to the distance between the robot and each frontier point. For example, the frontier point determiner 140 may set λ to 0.2, apply a weight of 0.2 to the distance between the robot and each frontier point and a weight of 0.8 to the coverage reward, and determine the frontier point.

In operation 1450, the frontier point determiner 140 may transmit a control command to the robot to move to the frontier point determined in operation 1440 for exploration or determine an exploration plan.

In operation 1460, the frontier point determiner 140 may determine whether the robot's exploration has been completed. If the robot's exploration has been completed, the autonomous exploration system 100 may terminate the operation. If the robot's exploration has not been completed, the autonomous exploration system 100 may request the frontier region detector 110 to perform operation 1410.

Operations 1420 and 1430 may be performed in parallel, or their execution order may be reversed. In addition, depending on an embodiment, only one of operations 1420 and 1430 may be performed. If only one of operations 1420 and 1430 is performed, operation 1440 may determine, among frontier points, a frontier point to which the robot moves for exploration based on information determined in the performed operation.

According to an embodiment, the exploration efficiency of a robot performing indoor exploration may be improved by identifying a frontier region and determining, based on a distance between the robot and frontier points in the frontier region and coverage rewards of the frontier points, a frontier point to which the robot moves for exploration.

Meanwhile, the learning-based autonomous robot exploration system or learning-based autonomous robot exploration method may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include all computer storage media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In a specific case, multitasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed embodiments, can be made.

What is claimed is:

1. A learning-based autonomous robot exploration system comprising:
a frontier region detector configured to detect a frontier region corresponding to a real-time grid map by inputting the real-time grid map of a region in which a robot is located to a frontier region detection network;
a distance predictor configured to measure a distance between the robot and each frontier point included in the detected frontier region; and
a frontier point determiner configured to determine, among frontier points, a frontier point to which the robot moves for exploration based on the distance between the robot and each frontier point.

2. The learning-based autonomous robot exploration system of claim 1, wherein the frontier region detector is configured to
receive input information comprising a map in which a real-time exploration result is illustrated as an image and a location of the robot, and
generate the real-time grid map by converting the map in which the real-time exploration result is illustrated as an image so that the location of the robot is at a center.

3. The learning-based autonomous robot exploration system of claim 1, wherein the frontier region detection network is a network trained to detect a frontier region using a training grid map and frontier region information set as a ground-truth label corresponding to the training grid map.

4. The learning-based autonomous robot exploration system of claim 1, wherein the frontier region detector is configured to perform a fast front propagation (FFP)+ method comprising:
setting one of unknown cells as a seed cell, performing exploration from the seed cell, searching a frontier region adjacent to a free cell among unknown cells, performing inner propagation from a location of a robot in a free cell, and searching a frontier region adjacent to an unknown cell among free cells.

5. The learning-based autonomous robot exploration system of claim 1, wherein the frontier region detector is configured to output a frontier region (FR) map illustrating the detected frontier region, and
the distance predictor is configured to measure a score according to the distance between the robot and each frontier point by inputting an obstacle map generated by extracting regions identified as obstacles from the real-time grid map, Gaussian robot location information, and the FR map to a distance measurement network.

6. The learning-based autonomous robot exploration system of claim 5, wherein the distance predictor is configured to train the distance measurement network by determining an A* map illustrating a distance between the robot and each frontier point detected from a training grid map using an A* algorithm, generating an inverted A* map by inverting the A* map, and setting the inverted A* map as a ground-truth label.

7. The learning-based autonomous robot exploration system of claim 5, wherein the Gaussian robot location information is an image generated by applying a Gaussian distribution around a location of the robot after placing the robot at a center of the image.

8. A learning-based autonomous robot exploration system comprising:
a frontier region detector configured to detect a frontier region corresponding to a real-time grid map by inputting the real-time grid map of a region in which a robot is located to a frontier region detection network;
a coverage reward predictor configured to predict a coverage reward generatable when the robot moves to a corresponding frontier point for each frontier point included in the detected frontier region; and
a frontier point determiner configured to determine, among frontier points, a frontier point to which the robot moves for exploration based on the predicted coverage reward.

9. The learning-based autonomous robot exploration system of claim 8, wherein the frontier region detector is configured to output a frontier region (FR) map illustrating the detected frontier region, and
the coverage reward predictor is configured to predict the coverage reward by inputting the real-time grid map and the FR map to a coverage reward prediction network.

10. The learning-based autonomous robot exploration system of claim 9, wherein the coverage reward predictor is configured to place a virtual robot at each frontier point of a training grid map, perform 360-degree ray-shooting from the virtual robot, determine whether pixels hit by rays correspond to obstacles, set a visibility map illustrating an obstacle determination result as a ground-truth label, and train the coverage reward prediction network using the visibility map.

11. The learning-based autonomous robot exploration system of claim 8, wherein the frontier region detection network is a network trained to detect a frontier region using a training grid map and frontier region information set as a ground-truth label corresponding to the training grid map.

12. A learning-based autonomous robot exploration system comprising:
a frontier region detector configured to detect a frontier region corresponding to a real-time grid map by inputting the real-time grid map of a region in which a robot is located to a frontier region detection network;
a coverage reward predictor configured to predict a coverage reward generatable when the robot moves to a corresponding frontier point for each frontier point included in the detected frontier region;
a distance predictor configured to measure a distance between the robot and each frontier point included in the detected frontier region; and
a frontier point determiner configured to determine, among frontier points, a frontier point to which the robot moves for exploration based on the distance between the robot and each frontier point and the predicted coverage reward.

13. The learning-based autonomous robot exploration system of claim 12, wherein the frontier point determiner is configured to determine the frontier point by applying a greater weight to the coverage reward than to the distance between the robot and each frontier point.

14. The learning-based autonomous robot exploration system of claim 12, wherein the frontier region detection network is a network trained to detect a frontier region using a training grid map and frontier region information set as a ground-truth label corresponding to the training grid map and is configured to output a frontier region (FR) map illustrating a frontier region corresponding to the real-time grid map.

15. The learning-based autonomous robot exploration system of claim 14, wherein the distance predictor is configured to measure a score according to the distance between the robot and each frontier point by inputting an obstacle map generated by extracting regions identified as obstacles from the real-time grid map, Gaussian robot location information, and the FR map to a distance measurement network.

16. The learning-based autonomous robot exploration system of claim 14, wherein the coverage reward predictor is configured to
place a virtual robot at each frontier point of a training grid map, perform 360-degree ray-shooting from the virtual robot, determine whether pixels hit by rays correspond to obstacles, set a visibility map illustrating an obstacle determination result as a ground-truth label, and train a coverage reward prediction network using the visibility map, and
predict the coverage reward by inputting the real-time grid map and the FR map to the coverage reward prediction network.
